(19) United States
(12) Patent Application Publication
(10) Pub. No.: US 2025/0330337 A1
(43) Pub. Date: Oct. 23, 2025

(54) PORTABLE DEVICES FOR CHECKING COVERAGE OF FIBER OPTIC LINKS

(71) Applicant: Fibercop S.p.A., Milano (IT)

(72) Inventors: Giuseppe SAMPOGNA, Trani (IT); Massimo ZAFFIRO, Napoli (IT)

(21) Appl. No.: 18/870,238

(22) PCT Filed: May 9, 2023
(86) PCT No.: PCT/EP2023/062293

§ 371 Date: Nov. 27, 2024

(30) Foreign Application Priority Data
May 31, 2022 (IT) 102022000011552

(51) Int. Cl. H04L 9/40; G01S 19/14; H04B 10/07; H04W 12/03

(52) U.S. Cl. CPC H04L 9/40; H04B 10/07; H04W 12/03; G01S 19/14

(57) ABSTRACT

A device for checking coverage of a fiber optic link of a fiber optic network, the fiber optic link configured to connect an apparatus of a telecommunications service provider and terminal equipment within the fiber optic network, may include: a processing unit; a positioning unit; a modem unit; and a connection enabler. The modem unit may be configured to connect to the fiber optic link at the terminal equipment and may be configured to retrieve data indicating that the fiber optic link is established. The positioning unit may be configured to provide geographical coordinates of the device. The processing unit may be configured to provide encrypted data by encrypting the data indicating that the fiber optic link is established and the geographical coordinates of the device. The connection enabler may be configured to transmit the encrypted data to a coverage checking server via a mobile communication network.

### TECHNICAL FIELD

The present invention relates to the field of fiber optic networks. In particular, the present invention relates to the field of checking the coverage of a fiber optic link in a fiber optic network, in particular in a FTTH (Fiber-To-The-Home) network.

### BACKGROUND ART

As known, in a FTTH (Fiber-To-The-Home) network, a fiber optic link is provided between the central office of the telecommunications service provider (simply, service provider), where an Optical Line Termination (OLT) apparatus is housed, and the customer's premises, where an Optical Network Terminal (ONT) apparatus is located.

In a point-to-point topology, the connection between the OLT and the ONT comprises a dedicated fiber optic link. In a point-to-multipoint topology, a PON (Passive Optical Network), in particular a GPON (Gigabit-capable Passive Optical Network), is typically used to transport the optical signal from the OLT to multiple ONTs by deploying optical fibers with optical splitters in a tree architecture, which are usually referred to as Optical Distribution network (ODN). An OLT typically comprises a number of ports and each of these ports, when active, realizes an operating optical tree at the end of which a number of users is connected.

When an FTTH network is deployed, an Optical Termination Box (OTB) is typically installed where the distribution network is terminated, e.g., in the building where the customer's premises are located. The OTB provides connectivity to the customers, whose equipment is typically connected to the OTB by means of drop cables.

At the end of the OTB deployment process, it is needed to check the coverage of the fiber optic link between the OLT and the OTB (i.e., to test whether the fiber optic link correctly reaches the considered OTB from the OLT), to verify that the installation works correctly. Prior art techniques provide for testing the fiber optic link by means of an optical time-domain reflectometry (OTDR) instrument installed in the service provider's central office. Alternatively, an operator with a portable OTDR instrument may perform the test at the OTB location.

Examples of prior art techniques and devices are briefly acknowledged herein after.

U.S. Pat. No. 8,588,571 B1 discloses a technique for installing a fiber optic network including preparing a physical site to install a feeder cable and a plurality of access stub lines along a plurality of customer premises that potentially may connect to the feeder cable to obtain communication services. Each of the access stub lines extends from the feeder cable towards a customer premise and each ends at a different initial termination point. There is a one-to-one correspondence between the customer premises and the access stub lines extending from the feeder cable. A demarcation device is attached to an end of each of the access stub lines at each of the initial termination points. The demarcation device includes an optical reflector that is reflective to an optical test signal for testing integrity of the feeder cable and an associated one of the access stub lines.

WO 2014/070511 A1 discloses an optical splitter assembly including a splitter housing, a passive optical power splitter positioned within the splitter housing and a plurality of splitter output pigtails that extend outwardly from the splitter housing. Each of the splitter output pigtails including an optical fiber structure having a first end optically coupled to the passive optical power splitter and a second end on which a fiber optic connector is mounted. Each of the splitter output pigtails having a different test characteristic such that the splitter output pigtails can be individually identified during optical network testing.

US 2013/022350 A1 discloses an optical-fiber-network (OFN) radio-frequency identification (RFID) method for deploying and/or provisioning service and/or locating faults in an OFN. The method includes providing at least one RFID tag on at least one OFN component of a plurality of OFN components that constitute an OFN and writing OFN component data to the at least one RFID tag that relates to at least one property of the OFN component associated with the RFID tag. The RFID tag data is written to and read from the RFID tags using one or more mobile RFID readers. The OFN component data is recorded and stored in an OFN database unit. The plurality of OFN components are deployed and operations of the

OFN are provisioned using the OFN component data. The method may also include using the OFN component data and a plurality of locations on a spatial map to locate a fault in the OFN.

### SUMMARY OF THE INVENTION

The inventors noticed that checking the coverage of the fiber optic link between the OLT and OTB by testing the fiber optic link at the OLT is burdensome (also from the point of view of involved costs for the testing equipment) and may be not reliable. Indeed, the FTTH network is a passive network and the identification of the OTB is typically performed by an operator who has to determine a reflection signal on the layout image of the reflectometry measurement. This technique may provide a wrong association between the estimated position of the OTB determined by the operator on the basis of the data provided by the testing equipment and the actual address of the building where the OTB is located.

The option of sending an operator on site at the building where the OTB is located with a portable OTDR instrument is equally burdensome as it is expensive and requires specialized skills.

In view of the above, the Applicant has tackled the problem of providing a device and a system for checking the coverage of a fiber optic link which overcomes the aforesaid drawbacks. In particular, the Applicant has tackled the problem of providing a device and a system for checking the coverage of a fiber optic link which allows testing the fiber optic link in a simpler and more reliable way with respect to prior art techniques. As it will be apparent form the following description, the present invention also allows testing the fiber optic link in a secure way.

In the following description and in the claims, the expression “checking the coverage of a fiber optic link”, the fiber optic link being deployed within a fiber optic network between an apparatus at the central office of the telecommunications service provider (e.g., an OLT) and a terminal equipment (e.g., an OTB or an ONT) located at an expected location within the fiber optic network, refers to:
checking whether the fiber optic link is established between the central office apparatus and the considered terminal equipment (which comprises checking whether an identifier of the device used to check the coverage of the fiber optic link at the considered terminal equipment is actually comprised within a list of identifiers of equipment connected to active ports of the apparatus and/or checking whether a specific coverage checking code set at the considered terminal equipment corresponds to a corresponding code available at the central office apparatus); and
checking the location of the terminal equipment of the fiber optic link, which means ascertaining that the actual location of the terminal equipment of the fiber optic link is the expected location thereof.

According to a first aspect, the present invention provides a device for checking the coverage of a fiber optic link of a fiber optic network, the fiber optic link connecting an apparatus at a central office of a telecommunications service provider and a terminal equipment located within the fiber optic network, the device comprising:
a processing unit;
a positioning unit;
a modem unit; and
a connection enabler,
the modem unit being configured to be connected to the fiber optic link at the terminal equipment and to retrieve data indicating that the fiber optic link is established,
the positioning unit being configured to provide the geographical coordinates of the device,
the processing unit being configured to provide encrypted data by encrypting the data indicating that the fiber optic link is established and the geographical coordinates,
the connection enabler being configured to transmit the encrypted data to a coverage checking server via a mobile communication network.

Preferably, the connection enabler is further configured to transmit to the coverage checking server also an identifier of the modem unit.

Preferably, the positioning unit is a global navigation satellite system unit.

Preferably, the processing unit is configured to encrypt the data indicating that the fiber optic link is established and the geographical coordinates by using a 64-bit encryption technique.

Preferably, the processing unit is configured to retrieve an information indicating a date and time of the day when the geographical coordinates are provided and to encrypt also the information indicating a date and time of the day together with the data indicating that the fiber optic link is established and the geographical coordinates.

Preferably, the device further comprises a visual signaling unit configured to show the data indicating that the fiber optic link is established and/or the geographical coordinates to an operator handling the device.

Preferably, the processing unit is configured to start a timer upon the providing the geographical coordinates by the positioning unit, the timer being of a predefined duration between one minute and ten minutes.

Preferably, the modem unit is further configured to retrieve a reception power indicating the power at which the modem unit receives an optical signal from the fiber optic link, and a transmission power indicating the power at which the modem unit transmits an optical signal over the fiber optic lin.

Preferably, the device comprises a mobile device including the processing unit, the positioning unit and the connection enabler.

Preferably, the modem unit is configured to be connected to the processing unit of the mobile device on one side and to a fiber optic cable on the other side to connect the device to the terminal equipment.

According to an exemplary embodiment, the modem unit is an ONT SFP (Small Form Factor Pluggable) module. According to this embodiment, the device further comprises a media converter module and an adapter module interposed between the processing unit and the ONT SFP module, the media converter module comprising an SFP slot to host the ONT SFP module and a LAN interface, the adapter module being attached to a port of the mobile device and comprising a further LAN interface towards the media converter module.

Preferably, the device further comprises a container in which the processing unit, the positioning unit, the modem unit and the connection enabler are enclosed in a non-releasable manner.

Preferably, the device is portable.

According to a second aspect, the present invention provides a system comprising the device as set forth above and the coverage checking server, wherein the server comprises a coverage checking application software configured to decrypt the encrypted data, retrieve the geographical coordinates and compare them with expected geographical coordinates of the terminal equipment as stored in a network inventory managed by the service provider.

According to embodiments of the present invention, the coverage checking application is configured to use the identifier of the modem unit to retrieve a decryption key uniquely associated with the first device to decrypt the encrypted data.

Preferably, the coverage checking application is further configured to check whether the identifier of the modem unit is comprised within a list of identifiers of equipment connected to active ports of the apparatus.

### BRIEF DESCRIPTION OF THE DRAWINGS

The present invention will become clearer from the following detailed description, given by way of example and not of limitation, to be read with reference to the accompanying drawings, wherein:

FIG. 1 schematically shows a fiber optic network comprising a fiber optic link and a device for checking the coverage of the fiber optic link according to an embodiment of the present invention;

FIG. 2 is a block scheme of the device for checking the coverage of the fiber optic link of FIG. 1;

FIG. 3 is a flowchart illustrating the operation of the device for checking the coverage of the fiber optic link of FIG. 2; and

FIG. 4 is a flowchart illustrating steps of a method for checking the coverage of the fiber optic link using the device of FIG. 2.

### DETAILED DESCRIPTION OF PREFERRED EMBODIMENTS OF THE INVENTION

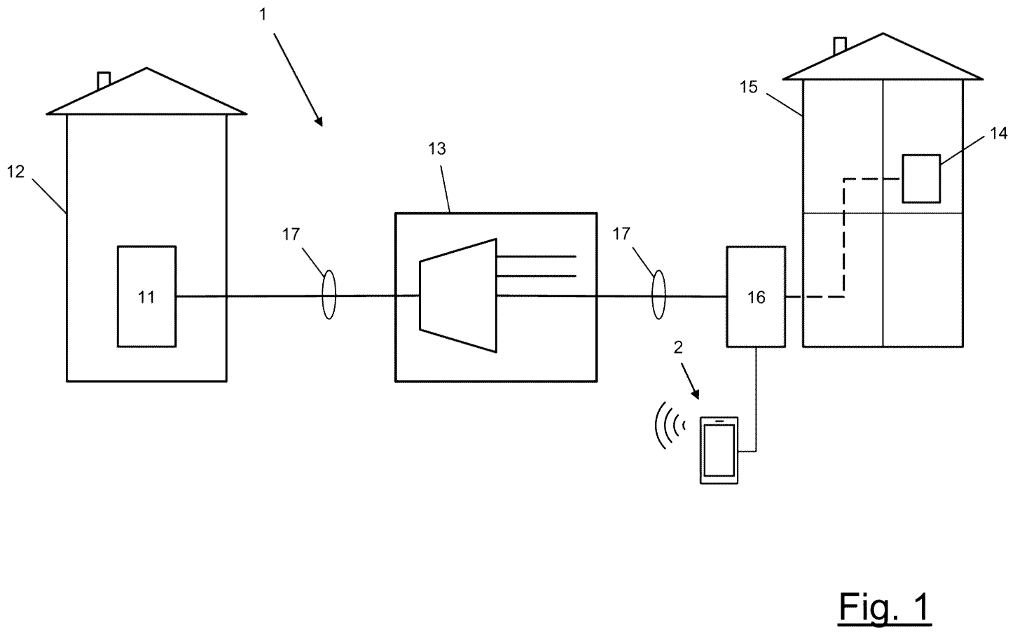

FIG. 1 schematically shows a fiber optic network, in particular, an exemplary FTTH network, which will be considered as a non-limiting example of a fiber optic network to which the present invention may be applied. More in particular, the exemplary fiber optic network schematically shown in FIG. 1 is a passive optical network.

The exemplary fiber optic network 1 shown in FIG. 1 is a point-to-multipoint fiber optic network. This is not limiting as the present invention may similarly apply also to other kinds of network such as for instance a point-to-point network. The fiber optic network of FIG. 1 comprises an optical line termination (OLT) 11 which is located at a central office 12 of a service provider. The OLT, as known, is, on the one side, connected to the core network of the service provider (not shown in the drawings) and, on the other side, to a distribution network via a number of ports (one of them being shown in FIG. 1). From each port, a fiber optic cable of the distribution network connects the OLT to a respective splitter 13, from which a number of further fiber optic cables of the distribution network depart, each of these fiber optic cables reaching one or more user nodes 14, typically referred to as optical network units (ONUs) or optical network terminals (ONTs), which are installed at the premises of the users. A port of the OLT is indicated as “active” when it is configured to be connected to one or more ONTs through respective fiber optic links. FIG. 1 schematically shows one single ONT 14 located at a user's premises in a building 15. An end-to-end link comprising multiple spans of fiber optic cables connects the OLT 11 and the ONTs at the user's premises. The exemplary fiber optic network 1 of FIG. 1 also comprises a terminal equipment (16), specifically an optical termination box (OTB) 16 located outside or inside the building 15 (e.g., on a wall or underground). A drop cable is typically used to reach the user's premises from the OTB 16.

As known, the telecommunications service provider providing his services over the fiber optic network typically maintains a server, which will be called “inventory server” herein after, comprising a network database or network inventory containing data identifying the network elements which have been deployed within the fiber optic network (namely, in the passive optical network described above, OLTs, splitters, OTBs, etc.). The data may comprise, for each network element, an identifier associated with the network element (e.g., a serial number) and the geographical coordinates (latitude and longitude) of the location of the network element.

The following description will relate to checking the coverage of the fiber optic link starting from the OLT 11 and terminating at the OTB 16, which will be indicated as fiber optic link 17. Anyway, this is not limiting as the device that will be described herein below may be used to check the coverage of any fiber optic link connecting the OLT and a terminal equipment of the fiber optic link located within the fiber optic network (such as, in a passive optical network, a fiber optic link connecting the OLT and an OTB, the OLT and an ONT, the OLT and a splitter, etc.).

The present invention is related to a device for checking the coverage of the fiber optic link 17. Moreover, the present invention is related to a system for checking the coverage of the fiber optic link 17 comprising the device and a server (which will be indicated as “coverage checking server”) to which the device may be connected via a mobile communication network, as it will be described herein after.

According to the present invention, the device for checking the coverage of the fiber optic link (which will be indicated as “verification device”) comprises:
a processing unit;
a positioning unit;
a modem unit; and
a connection enabler.

The modem unit is configured to be connected to the fiber optic link 17 at the terminal equipment 16 and to retrieve data indicating that the fiber optic link is established. The positioning unit is configured to provide geographical coordinates of the verification device. The processing unit is configured to provide encrypted data by encrypting the data indicating that the fiber optic link 17 is established and the geographical coordinates. The connection enabler comprises a long-range connectivity function in that it is configured to transmit the encrypted data to the coverage checking server via a mobile communication network for completing the operation of checking the coverage of the fiber optic link, as it will be described herein after.

The verification device of the present invention is configured to be handled by an operator to check the coverage of a fiber optic link of the considered fiber optic network. The verification device is hence a portable device.

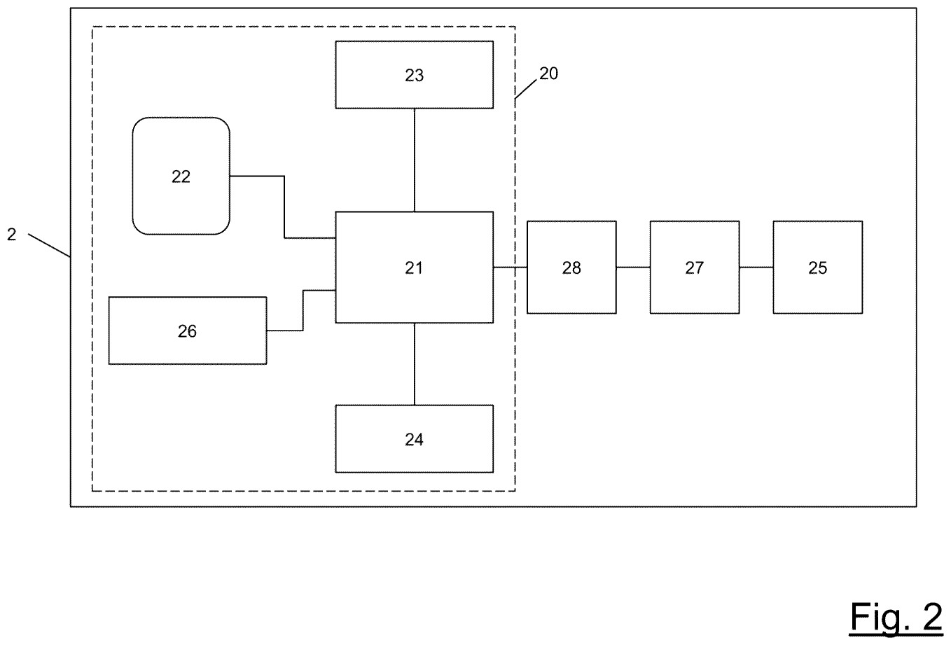

FIG. 2 shows a block scheme illustrating the building blocks of a verification device 2 for checking the coverage of the fiber optic link according to an embodiment of the present invention.

The verification device 2 schematically represented in FIG. 2 preferably comprises:
a processing unit 21;
a battery 22;
a positioning unit 23;
a connection enabler 24;
a modem unit 25; and
optionally, a visual signaling unit 26, such as a display.

The verification device 2 preferably comprises a mobile device 20 such as a smartphone or an equivalent portable device, provided with a CPU as processing unit 21, a battery 22, a satellite positioning unit as positioning unit 23 and a display 26. The positioning unit 23 is preferably a global navigation satellite system (GNSS) unit, more preferably a GPS (Global Positioning System) receiver.

The mobile device 20 also includes a transmission unit as connection enabler 24, the transmission unit providing a long-range connectivity function as part of the verification device 2. In particular, the connection enabler 24 of the mobile device 20 preferably comprises a long-range connectivity function in that it is configured to enable the mobile device 20 to access a mobile communication network managed by any mobile service provider and provide a wireless connection (such as a 3G+, 4G or 5G connection) to, e.g., the Internet through the mobile communication network. The connection enabler 24 of the mobile device 20 may comprise a SIM card or the like. Further, the mobile device 20 preferably comprises a non-volatile memory configured to store data comprising an identifier (e.g., a serial number) associated with the modem unit 25 and other data provided by the modem unit 25 and related to the link connectivity, as it will be described herein after. The mobile device 20 may also comprise a RFID reader and/or a Bluetooth transceiver and/or a ZigBee transceiver and/or a Wi-Fi transceiver.

The mobile device 20 may advantageously be configured to read machine-readable optical labels such as QR codes.

The mobile device 20 is preferably provided with a client component of an application software (in the following, briefly, application or app) configured to, in particular, process the data provided by the modem unit 25 as it will be described in detail herein after. The application is preferably a web application which exploits processing capabilities resident on an application server managed by the service provider. In particular, the application server may connect to the inventory server of the service provider for exchanging data with it to process the data provided by the modem unit 25, as it will be described herein after. This application will be indicated as “coverage checking application” and the application server is the coverage checking server already mentioned above.

The modem unit 25 of the verification device 2 is configured to be connected to the processing unit 21 of the mobile device 20 on one side and to a fiber optic cable on the other side. According to the embodiment of the present invention schematically represented in the Figures, the modem unit 25 is preferably a stand-alone transceiver module configured to be connected to the mobile device 20, possibly via intermediate interface modules. The modem unit 25 may be in the form of a GPON ONT SFP (Small Form Factor Pluggable) module. According to other embodiments not shown in the Figures, the modem unit 25 may be embedded in the mobile device 20.

The modem unit 25 is preferably associated with an identifier (e.g., a serial number).

According to a preferred embodiment, the modem unit 25 is a ONT SFP module. In this case, in order to connect the ONT SFP module 25 to the mobile device 20, the verification device 2 is preferably provided with interface modules, namely a media converter module 27 and an adapter module 28, wherein both modules are interposed between the ONT SFP 25 and the mobile device 20. In particular, the adapter module 28 is attached to a port of the mobile device 20, e.g., a USB (Universal Serial BUS) or USB-C port of the mobile device, and provides an interface (e.g., a LAN interface, in particular an RJ-45 interface) for the media converter module 27. The media converter module 27 preferably has an SFP slot to host the ONT SFP module 25 and an interface (e.g., a LAN interface, in particular an RJ-45 interface) for the adapter module 28. In this way, the mobile device 20 is advantageously enabled to exchange data with the ONT SFP 25 in order to check the coverage of the fiber optic link 17, as it will be described herein below.

The modem unit 25 is provided with a fiber optic connector (not shown in the drawings) for connecting a fiber optic cable. Indeed, in the exemplary fiber optic network of FIG. 1, the modem unit 25 is configured to be connected to the OTB 16 by means of a fiber optic cable having a length of a few meters, e.g., five meters, and to receive from the OTB 16 an optical signal transported over the fiber optic link under test 17.

The operation of a modem unit as described above is known and will not be described in greater detail.

The mobile device 20, the modem unit 25 and the other possible components of the verification device 2 interposed between the mobile device 20 and the modem unit 25 (e.g., the media converter module 27 and the adapter module 28 described above) are preferably tamper-proof sealed within a container in order to avoid manipulations.

According to the present invention, the operation of coverage checking of the fiber optic link 17 comprises connecting the verification device 2 to the OTB 16 and:
(i) checking that the fiber optic link 17 is established between the OLT 11 and the modem unit 25 of the verification device 2 connected to the OTB 16;
(ii) checking that the location of the OTB 16 corresponds to the expected location as stored in the network inventory; and
(iii) checking that the identifier of the modem unit 25 (e.g., the serial number) of the verification device 2 is comprised within a list of identifiers of the ONTs actually connected to active ports of the OLT 11.

According to a variant, the operation of coverage checking of the fiber optic link 17 at the OTB 16 comprises, alternatively or in addition with respect to the checking operation at point (iii) above, checking that a configuration information that is associated with the modem unit 25 when the verification device 2 is operated to check the coverage at the OTB 16 corresponds to a configuration information that is stored at the OLT 11 as associated with the modem unit 25 upon a link being established between the OTL 11 and the modem unit 25, as it will be described In greater detail herein after. The configuration information may be the content of a “password” field that is configured in the modem unit 25 by the processing unit 21 via, for instance, the interface modules described above. Advantageously, the processing unit 21 may set a different value of this configuration information in the modem unit 25 each time the verification device 2 is used to check the coverage of a respective fiber optic link. The configuration information will be indicated herein after as “coverage checking code”. The coverage checking code is hence uniquely associated with the modem unit 25 and with the coverage checking operation at the specific OTB 16, and it may be used to securely check that the OLT 11 is connected to the verification device 2 when the coverage checking at the location of the OTB 16 is performed. As a matter of fact, using the serial number of the modem unit 25 at point (iii) above may have a potential drawback. Indeed, the serial number of the modem unit 25 may be cloned to another ONT possibly located at a position remote from the OTB 16, which may be used to provide a false coverage check. Using the coverage checking code as defined above advantageously allows overcoming this potential drawback.

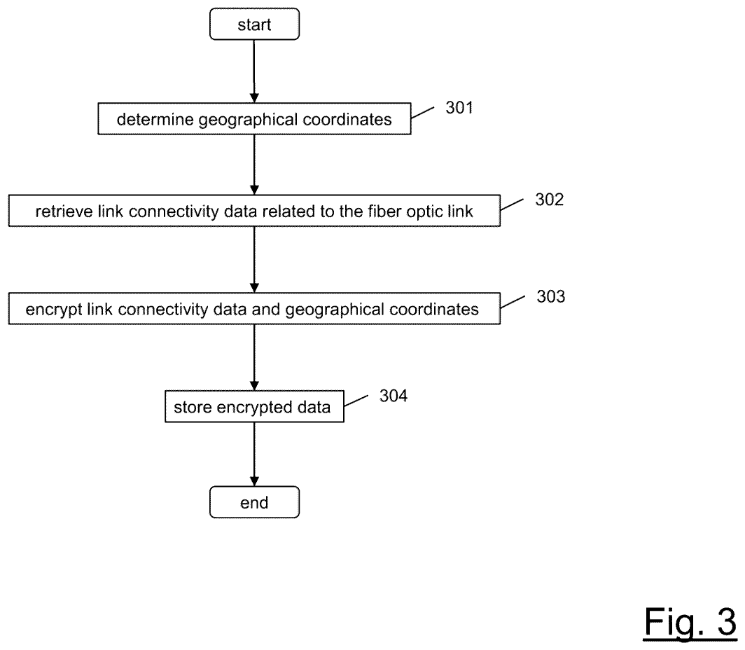

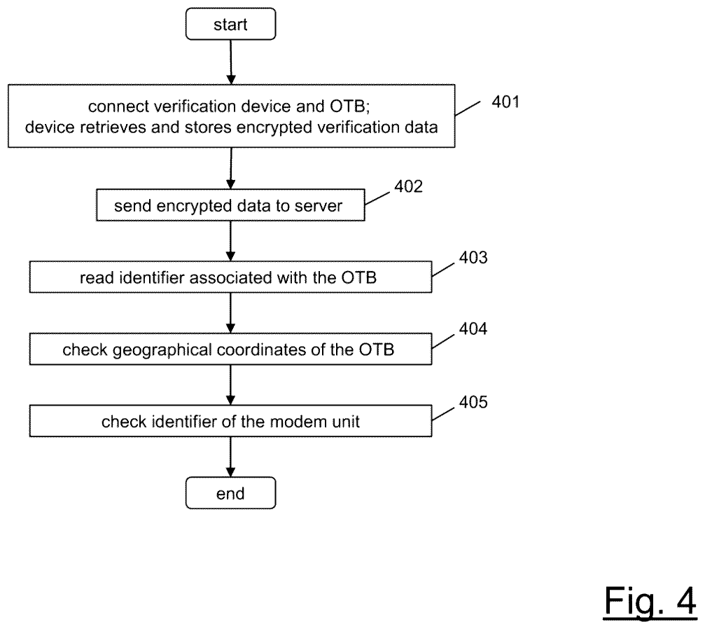

The operation of the verification device 2 according to the embodiment of the present invention schematically represented in FIG. 2, will be described herein below with reference to the flowcharts shown in FIG. 3 and FIG. 4.

It is assumed that the operator handling the verification device 2 reaches the location of the OTB 16 to check the coverage of the fiber optic link 17 terminating therein.

When the verification device 2 is at the OTB location, the positioning unit 23 preferably provides the geographical coordinates of the verification device 2 (step 301), namely the latitude and longitude. These geographical coordinates substantially correspond to the geographical coordinates of the OTB 16. Once the geographical coordinates are determined, the processing unit 21 preferably operates the visual signaling unit 26, if present, to show the geographical coordinates to the operator. In the meantime, the processing unit 21 may start a timer of a predefined duration, which may vary between one minute and ten minutes (e.g., four minutes). The timer sets a time interval of the predefined duration mentioned above within which the operator is supposed to connect the verification device 2 to the OTB 16 and complete the procedure to check the coverage of the fiber optic link 17, as it will be described herein below with reference to the flowchart of FIG. 4. If the timer expires before the operator completes the procedure, the coverage checking is considered not valid.

It is to be appreciated by the skilled person that the use of the timer allows increasing the security of the coverage checking as it allows avoiding any mismatch between the actual position of the OTB 16 and the position at which the operator is currently collecting the geographical coordinates. Indeed, this would reduce the risk of a fraudulent behaviour by an operator who collects the geographical coordinates at a location which does not correspond to the actual location of the OTB 16, and then moves away from that location to the actual position of the OTB 16 to physically connect the verification device 2 to the OTB 16 for performing the other operations needed to complete the coverage check.

At step 302, preferably, the verification device 2 is connected to the OTB 16 by means of a fiber optic cable which is plugged, at one end, in the fiber optic connector of the modem unit 25 of the verification device 2 and at the other end in a corresponding connector comprised in the OTB 16. At this point, the operator preferably waits until the modem unit 25 aligns with the port of the OLT 11 which is active at the central office node 12. In other words, the operator waits for the connection to be set up between one of the available ports at the OLT 11 and the modem unit 25 of the verification device 2. The alignment procedure of a modem is known and will not be described in further detail herein after. Once aligned, the modem unit 25 starts receiving an optical signal from the fiber optic link 17 and in turn starts transmitting an optical signal over the fiber optic link 17. It preferably converts the received optical signal into an electrical signal, which is transferred to the processing unit 21 via the media converter module 27 and the adapter module 28.

It is to be noticed that the operations described above related to steps 301 and 302 may also be performed in parallel or in reverse order.

Then, the processing unit 21 preferably processes the received electrical signal and retrieves the following data, which will be referred to as link connectivity data:
a link status information indicating that the fiber optic link 17 is established;
an information (namely, a port identifier) indicating the actual alignment port of the OLT 11, namely the OLT active port to which the modem unit 25 is connected;
a reception power (or RX power) indicating the power at which the modem unit 25 receives the optical signal from the fiber optic link 17. In current commercial modems, this kind of information is typically indicated as “RX level”; and
a transmission power (or TX power) indicating the power at which the modem unit 25 transmits the optical signal over the fiber optic link 17. In current commercial modems, this kind of information is typically indicated as TX level.

Once the fiber optic link 17 is established and the link connectivity data are retrieved, the processing unit 21 preferably operates the visual signaling unit 26, if present, to show the link connectivity data to the operator.

For instance, when the fiber optic link 17 is established between the OLT 11 and the OTB 16, the link status information indicates the presence of the optical signal over the fiber optic link 17. In this case, the visual signaling unit 26 may show the link status information represented by a message such as “link status OK”. Moreover, the reception power and transmission power information may be processed (automatically by the device, or by the operator) to check if the RX power is too low and hence to detect a possible failure or degradation in the fiber optic link 17. Furthermore, the operator may also process the port identifier of the OLT active port retrieved by the verification device 2 and detect a possible OLT port inversion, which, as known, could cause problems.

The processing unit 21 also recovers the identifier of the modem unit 25. The identifier of the modem unit 25 may be shown on the visual signaling unit 26 together with the link connectivity data described above.

According to the advantageous variant already mentioned above, when the verification device 2 is operated at the OTB location, the processing unit 21 also generates a pseudo-random number (e.g., a 10-digit number) and, via the media converter module 27 and the adapter module 28, configures the modem unit 25 with a coverage checking code comprising the generated pseudo-random number. In particular, for instance, the processing unit 21 may set the content of a “password” field of the modem unit 25 with the coverage checking code. When the fiber optic link 17 is established between the OLT 11 and the OTB 16, the OLT 11 preferably reads the coverage checking code from the modem unit 25 and stores it for future check, as described herein below. According to this variant, at step 302, the coverage checking code may be shown on the visual signaling unit 26 together with the link connectivity data described above.

At step 303, the processing unit 21 preferably associates the link connectivity data and, according to the variant described above, the coverage checking code, with the geographical coordinates detected by the positioning unit 23 and with an information indicating the date and time of the day at which the link connectivity data are determined, which correspond to the date and time of the day at which the coverage check of the fiber optic link 17 is performed. The set of data comprising the link connectivity data, the geographical coordinates and the information indicating the date and the time of the day is referred to as “verification data”. According to the variant described above, the verification data also comprise the coverage checking code. At step 303, the processing unit 21 preferably encrypts the verification data. For instance, an encryption according to the known DES (Data Encryption Standard) protocol may be used, e.g., a 64-bit encryption technique.

Preferably, the processing unit 21 uses an encryption key which is uniquely associated with the verification device 2. In this way, different verification devices are preferably provided with different encryption keys. Then, if one encryption key disadvantageously becomes public, one may easily avoid a malicious usage of that key by not using the single verification device associated with the key that has become public. According to embodiments of the present invention, the encryption keys of the verification devices are stored in a key table which is provisioned and maintained by the service provider in the coverage checking server. Each encryption key is preferably stored in the key table as uniquely associated with the identifier of the modem unit of the respective verification device.

Preferably, the encrypted verification data and the identifier of the modem unit 25 are also stored in the memory of the mobile device 20 (step 304).

FIG. 4 is a flowchart illustrating the actions that may be performed (e.g., by the operator) when using the verification device 2 described above to check the coverage of the fiber optic link 17, and the steps performed at the coverage checking server cooperating with the verification device 2. For sake of simplicity, it is assumed that, according to a preferred embodiment of the present invention, the verification device 2 comprises a smartphone 20 whose positioning unit 23 is a GPS receiver. It is also assumed that the modem unit 25 is a ONT SFP module attached to the smartphone 20 via the media converter module 27 and the adapter module 28. Moreover, it is assumed that the OTB 16 comprises a further RFID tag containing an identifier (e.g., a serial number) associated with the OTB 16. Alternatively, or in addition, the identifier associated with the OTB 16 may be contained in a barcode (e.g., a QR code) attached to the OTB 16.

When the operator reaches the location of the OTB 16, the verification device 2 is operated to perform the steps of the method already illustrated above with reference to the flowchart of FIG. 3, which will be represented by step 401 in the flowchart of FIG. 4.

In particular, when the verification device 2 is operated at the location of the OTB 16, it preferably retrieves the geographical coordinates by means of the GPS receiver 23 of the mobile device 20. In the meanwhile, the operator connects the OTB 16 and the verification device 2 by means of a fiber optic cable which is plugged, at one end, in the fiber optic connector of the modem unit 25 of the verification device 2 and at the other end in a corresponding connector comprised in the OTB 16. The operator waits for the connection to be set up between one of the available ports at the OLT 11 and the modem unit 25 of the verification device 2. If the modem unit 25 fails to align with an active port of the OLT 11, the coverage checking of the fiber optic link 17 fails and the verification device 2, for instance, may return a warning message to the operator through the display 26 of the smartphone 20. When the connection is set up, the verification device 2 retrieves the link connectivity data. Moreover, according to the variant described above, the processing unit 21 configures the modem unit 25 with the coverage checking code that has been generated for this specific coverage check operation. When the connection is set up, the coverage checking code is then read by the OLT 11.

Then, the verification device 2 preferably encrypts the verification data comprising the link connectivity data, the geographical coordinates and the date and time of the day information. According to the variant described above, the verification data comprise also the coverage checking code.

At this point, the operator may run the coverage checking application which is installed on the smartphone 20 to implement the coverage checking operation, as follows. When the coverage checking application is running on the smartphone 20, the smartphone 20 is preferably operated to connect to the application server, whose processing capabilities are exploited to perform the operations described herein below.

At step 402, the operator preferably interacts with the coverage checking application to operate the smartphone 20 to send the encrypted verification data and the identifier of the modem unit 25 to the application server through the connection enabler 24 of the smartphone 20. Once the data are decrypted, they are used for the checks that will be described herein after and they are stored by the service provider to keep track of the coverage check for the considered fiber optic link.

At step 403, the operator preferably interacts with the coverage checking application to acquire the identifier associated with the OTB 16. To this purpose, the operator may use the RFID reader of the smartphone 20 to read the identifier associated with the OTB 16 stored in the RFID tag associated with the OTB 16. Alternatively, the operator may use the smartphone 20 to read the machine-readable optical label (e.g., a QR code) containing the identifier associated with the OTB 16 and attached thereto. To this purpose, for example, the operator may use a QR code reader installed in the smartphone 20.

At step 404, preferably, the coverage checking application decrypts the encrypted verification data. Decryption is preferably performed at the coverage checking server by using the identifier of the modem unit 25 to read the key table comprising the encryption keys and retrieve the encryption key uniquely associated with the verification device 2. This encryption key is then used by the coverage checking server to decrypt the encrypted verification data.

Then, preferably, the coverage checking application checks the geographical coordinates that have been measured by the GPS receiver 23 of the smartphone 20. In particular, the coverage checking application operates the smartphone 20 to send the identifier of the OTB 16 to the application server which uses the identifier of the OTB 16 to interrogate the network inventory of the inventory server and retrieve the GPS coordinates of the OTB 16 that are stored in the network inventory as associated with the identifier of the OTB 16. These GPS coordinates are indeed the GPS coordinates of the expected location of the OTB 16. The coverage checking application then compares the GPS coordinates measured by the verification device 2 with the GPS coordinates of the OTB 16 as stored in the network inventory of the inventory server. In particular, the location corresponding to the GPS coordinates measured by the verification device 2 is compared with the location corresponding to the GPS coordinates of the OTB 16 as stored in the network inventory. If the distance between the measured location and the stored location is less than a predefined tolerance distance of, e.g., 30 m, the coverage checking application preferably determines that the measured location matches the stored (expected) location.

If the distance between the measured location and the stored location is higher than the predefined tolerance distance, the coverage checking application preferably operates the smartphone 20 to provide a warning message to the operator (either a visual message to be shown on the display 26 of the smartphone 20 or an audio message to be reproduced by the speaker of the smartphone 20 or a combination of the two types of messages) indicating that the coverage check of the fiber optic link 17 has failed. In this case, the GPS coordinates of the OTB 16 stored in the network inventory may be overwritten with the GPS coordinates measured by the verification device 2 and sent to the application server.

At step 405, preferably, the coverage checking application provides for the application server to interrogate the OLT 11 at the service provider's central office and to request a list comprising the identifiers (e.g., the serial numbers) of the ONTs 14 actually connected to active ports of the OLT 11. Once the list is retrieved from the OLT 11, preferably, the coverage checking application checks whether the identifier associated with the modem unit 25 of the verification device 2 is comprised in the list collected from the OLT 11. If the identifier associated with the modem unit 25 of the verification device 2 is comprised in the list collected from the OLT 11, the coverage checking application preferably determines that the modem unit 25 is actually connected to an active port of the OLT 11 and preferably provides a corresponding confirmation message to the operator on the display 26 of the smartphone 20. If, otherwise, the identifier associated with the modem unit 25 of the verification device 2 is not comprised in the list collected from the OLT 11, the coverage checking application provides a warning message to the operator on the display 26 of the smartphone 20 indicating a failure.

According to the variant described above, in addition or alternatively with respect the above-described check on the identifier of the modem unit 25, the coverage checking application provides for the application server to check whether the coverage checking code comprised in the verification data corresponds to the coverage checking code that has been read by the OLT 11 when the connection has been set up. If the coverage checking code comprised within the verification data provided by the verification device 2 corresponds to the coverage checking code available at the OLT 11, the coverage checking application preferably determines that the OLT 11 is actually connected to the modem unit 25 of the verification device 2 at the OTB 16 location (and not, for instance, to a clone ONT) and provides a corresponding confirmation message to the operator on the display 26 of the smartphone 20. If, otherwise, the coverage checking code comprised within the verification data does not correspond to the coverage checking code available at the OLT, the coverage checking application provides a warning message to the operator on the display 26 of the smartphone 20 indicating a failure.

If all the considered checks performed as described above return a positive outcome, the coverage checking application may provide a final confirmation message to the operator on the display 26 of the smartphone 20 indicating that the coverage check of the fiber optic link 17 is successful.

The device described above advantageously allows checking the coverage of a fiber optic link in an effective and reliable way. Indeed, the device is a portable device that can be easily handled by an operator and brought to the location where the coverage of the fiber optic link is to be checked to verify that the link is established and correctly working. The verification device has a simple architecture, and it may be operated in a simple manner. Moreover, it gives reliable and secure information. In particular, it provides the geographical coordinates of the location where the coverage check is performed in a reliable and secure manner. The coordinates are reliable as they are provided by the satellite positioning unit of the verification device connected in such a manner as to avoid any manipulation (for instance, the processing unit sets a timer which avoids that the operator moves during the coverage checking procedure and detects coordinates at a different location). Moreover, according to a preferred embodiment of the present invention, the components of the verification device are sealed in the container and cannot be manipulated. This means that the device provides an extremely reliable association between, for instance, the measured position of an OTB and the actual address of the building where the OTB is located. This also guarantees that data such as the identifier of the modem unit or the geographical coordinates cannot be maliciously modified for the coverage checking. The described use of a specific coverage checking code randomly generated at the verification device once the coverage checking operation is started allows further improving the reliability of the operation. Security of the data is also enhanced by encrypting the data obtained by the verification device prior to sending them to the coverage checking server.

1. A device for checking coverage of a fiber optic link of a fiber optic network, the fiber optic link configured to connect an apparatus at a central office of a telecommunications service provider and terminal equipment within the fiber optic network, the device comprising:
a processing unit;
a positioning unit;
a modem unit; and
a connection enabler;
wherein the modem unit is configured to connect to the fiber optic link at the terminal equipment and is configured to retrieve data indicating that the fiber optic link is established,
wherein the positioning unit is configured to provide geographical coordinates of the device,
wherein the processing unit is configured to provide encrypted data by encrypting the data indicating that the fiber optic link is established and the geographical coordinates of the device, and
wherein the connection enabler is configured to transmit the encrypted data to a coverage checking server via a mobile communication network.

2. The device of claim 1, wherein the positioning unit comprises a global navigation satellite system unit.

3. The device of claim 1, wherein the processing unit is further configured to encrypt the data indicating that the fiber optic link is established and the geographical coordinates of the device using a 64-bit encryption technique.

4. The device of claim 1, wherein the processing unit is further configured to retrieve information indicating a date and time of day when the geographical coordinates of the device are provided and to encrypt the information indicating the date and the time of day, together with the data indicating that the fiber optic link is established and the geographical coordinates of the device.

5. The device of claim 1, further comprising:
a visual signaling unit configured to show the data indicating that the fiber optic link is established and/or to show the geographical coordinates of the device to an operator handling the device.

6. The device of claim 1, wherein the processing unit is further configured to start a timer upon the providing of the geographical coordinates of the device by the positioning unit, and
wherein the timer is of a predefined duration greater than or equal to one minute and less than or equal to ten minutes.

7. The device of claim 1, wherein the modem unit is further configured to retrieve:
a reception power indicating a power at which the modem unit receives a first optical signal from the fiber optic link, and
a transmission power indicating a power at which the modem unit transmits a second optical signal over the fiber optic link.

8. The device of claim 1, comprising a mobile device that comprises the processing unit, the positioning unit, and the connection enabler.

9. The device of claim 8, wherein the modem unit is further configured to connect to the processing unit of the mobile device on a first side and to a fiber optic cable on a second side in order to connect the device to the terminal equipment.

10. The device of claim 9, wherein the modem unit comprises an optical network terminal small form factor pluggable (ONT SFP) module.

11. The device of claim 10, further comprising:
a media converter module; and
an adapter module between the processing unit and the ONT SFP module;
wherein the media converter module comprises an SFP slot to host the ONT SFP module and a first local area network (LAN) interface,
wherein the adapter module is configured to attach to a port of the mobile device, and
wherein the adapter module comprises a second LAN interface toward the media converter module.

12. The device of claim 1, further comprising:
a container in which the processing unit, the positioning unit, the modem unit, and the connection enabler are enclosed in a non-releasable manner.

13. The device of claim 1, wherein the device is portable.

14. A system, comprising:
the device of claim 1; and
the coverage checking server of claim 1;
wherein the coverage checking server comprises coverage checking application software configured to decrypt the encrypted data, to retrieve the geographical coordinates of the device, and to compare the the geographical coordinates of the device with expected geographical coordinates of the terminal equipment as stored in a network inventory managed by the telecommunications service provider.

15. The system of claim 14, wherein the coverage checking application software is further configured to check whether an identifier of the modem unit is comprised within a list of identifiers of equipment connected to active ports of the apparatus.

16. A system, comprising:
the device of claim 1; and
the coverage checking server of claim 1.

17. The device of claim 1, wherein the processing unit is further configured to encrypt the data indicating that the fiber optic link is established using a 64-bit encryption technique.

18. The device of claim 1, wherein the processing unit is further configured to encrypt the geographical coordinates of the device using a 64-bit encryption technique.

19. The device of claim 1, wherein the processing unit is further configured to retrieve information indicating a date and time of day when the geographical coordinates of the device are provided.

20. The device of claim 1, wherein the processing unit is further configured to retrieve information indicating a date and time of day when the geographical coordinates of the device are provided and to encrypt the information indicating the date and the time of day.
